(19) United States
(12) Patent Application Publication
(10) Pub. No.: US 2023/0187916 A1
(43) Pub. Date: Jun. 15, 2023

(54) System for Childproofing a Wall Outlet, While Functionally Moving and Aesthetically Hiding It and Securing an Electrical Cord or Data Cable to the Wall

(71) Applicant: Socket Solutions, LLC, Houston, TX (US)

(72) Inventor: Michael George Insalaco, Houston, TX (US)

(21) Appl. No.: 18/105,228

(22) Filed: Feb. 2, 2023

Related U.S. Application Data
(63) Continuation-in-part of application No. 17/185,894, filed on Feb. 25, 2021.
Application No. 17/185,894 is a continuation-in-part of application No. 17/175,604, filed on Feb. 12, 2021, now Pat. No. 11,450,997.

(51) Int. Cl. H02G 3/30

(52) U.S. Cl. CPC H02G 3/24; H01R 13/6395

(57) ABSTRACT

A system and method for childproofing and aesthetically improving a functional indoor electrical or coaxial wall outlet while retaining use of the outlet by effectively relocating the functionality of the outlet. A functional cover hides the wall outlet and moves the outlet's functionality to a desired location with an electrical cord or coaxial cable. That cord or cable extends from the cover to the desired location, supported by clips affixed to the wall and enclosing portions of the cord or cable. The clips are uniquely, strategically sized and shaped to complement or correspond to the circumferential size and shape of the cord or cable so that the cord or cable is held tightly and cannot be removed by children. The wall outlet cover, the cord or cable, and the clips have a substantially blank face and unobtrusive profile with each protruding outward from the wall less than about one inch.

### CROSS REFERENCE TO RELATED APPLICATIONS

This application claims priority from and is a continuation-in-part from U.S. patent application Ser. No. 17/185,894, filed Feb. 25, 2021, pending, which claims the benefit of U.S. patent application Ser. No. 17/175,604, filed Feb. 12, 2021, which issued as U.S. Pat. No. 11,450,997, on Sep. 20, 2022, the entire contents of which are incorporated herein by reference.

### BACKGROUND

### 1. Field

The present invention relates to electrical connector devices, data connector devices, and similar devices primarily for transmission of data such as radio frequency signals and digital data needed for operation of various electronic equipment used in homes, offices and schools, such as televisions and computers and peripheral devices associated with them. More particularly, the invention relates to indoor electrical wall outlets, and electrical cords extending from such outlets. The invention also relates to indoor data wall outlets, and coaxial data cables extending from such outlets. Most particularly, this invention relates to systems, methods and apparatuses for securing such electrical cords and coaxial data cables to adjacent walls near such outlets for child safety and aesthetics.

### 2. Description of Relevant Art

Electrical service in buildings, particularly in homes, offices, and schools, is typically provided at least in part through electrical wall outlets. Devices needing electrical current for operation or use have electrical cords ending in electrical plugs for connection to an electrical wall outlet. Once the plug is inserted into the wall outlet, electrical current can flow (or does flow if the wall outlet has electrical current flowing into it) to the cord for activating the device needing current.

Similarly, cable TV and/or cable internet service in buildings, particularly in homes, offices, and schools, are typically provided at least in part through data wall outlets. Devices needing radio frequency signals, digital data, or electrical current through a coaxial data cable for operation or use, typically have coaxial cable female connectors for connection to a male connector of a coaxial cable ending in a coaxial male or female plugs connector attached to a coaxial data cable wall outlet. Once the coaxial data cable is attached to the coaxial data cablewall outlet, radio frequency signals or digital data can transmit (or if applicable, electrical current can flow (or does flow if the coaxial wall outlet has electrical current flowing into it)) to the coaxial cable for transmission to the device needing the signal, data, or current.

Most typically, when an electrical plug with a cord or coaxial connector with a coaxial data cable is connected to an electrical or data wall outlet, respectively, the electrical plug and cord and the data cable connector and cable extend horizontally and eventually vertically several inches from the wall outlet before the electrical cord or data cable, as applicable, curves to an approximate parallel, unorganized posture with respect to the wall. As a consequence, furniture or other items positioned adjacent to the wall, and even the item plugged into, or connected to, the wall outlet, must be positioned sufficiently away from the wall outlet to accommodate the electrical plug and cord or data cable connector and cable attachment to the wall outlet to accommodate safety hazards from tripping over tangled, protruding electrical cords or data cables, as applicable, and also to accommodate someone's hand and often times arm in reaching behind the furniture to insert the plug into the wall outlet. Such positioning wastes space in the room and is generally unattractive.

Moreover, typically and commonly used electrical plugs and cords and data cables and connectors, each when attached to an electrical wall outlet or data wall outlet, respectively, are themselves generally unattractive and are known to pose a potential safety hazards. For example, infants and children are known to potentially insert objects into electrical wall outlet receptacles and get shocked and injured thereby; infants, children and pets are known to potentially chew on electrical cords and get shocked and injured thereby; and people generally are known to potentially trip and fall from tangled electrical cords and data cables and get injured thereby. Further, protrusion of the electrical plugs and cords and axial plugs and cables from the outlets and walls can result in a risk of injury to infants and children should they fall into or bump into such protruding plugs. Blank cover plates and individual non-conductive plugs are commonly used to prevent children from inserting objects into electrical wall outlet receptacles, but such plates and plugs then prevent use of the outlets.

U.S. Pat. No. 9,509,080, issued Nov. 29, 2016, to Insalaco, U.S. Pat. No. 9,525,232, issued Dec. 20, 2016 to Insalaco and U.S. Pat. No. 11,450,997 teach electrically functional indoor wall outlet covers that solve a number of these problems with electrical wall outlets, and U.S. Pat. No. 10,516,240, issued Dec. 24, 2019, to Insalaco teaches an indoor coaxial wall outlet cover that solves a number of these problems with coaxial wall outlets.

These electrically functional indoor wall outlet covers and the indoor coaxial wall outlet cover are each thin enough to allow furniture placement adjacent a wall in front of the outlets, and these respective covers are able to hide their respective associated wall outlets altogether while allowing the electrical functionality of the electrical outlet to be moved by an electrical cord and the data transmission functionality of the coaxial outlet to be moved by a coaxial cord. The electrical cord and coaxial cable extend respectively from these functional indoor wall outlet covers.

The functional electrical wall outlet covers of U.S. Pat. Nos. 9,509,080 and 9,525,232 are designed to effectively access electrical current from only one receptacle, particularly the top receptacle, and thus the second receptacle, particularly the bottom receptacle, in a duplex or one-gang electrical wall outlet is not accessed or used. These outlet covers have one electrical cord extending therefrom.

U.S. Pat. No. 11,450,997, which issued Sep. 20, 2022 to Insalaco, provides for the indoor electrical wall outlet cover to allow full access of electrical current from, and use of, both the top receptacle and the bottom receptacle of a duplex or one-gang electrical wall outlet. The back of the wall outlet cover of the apparatus of the present invention has extending outwardly from the back of it a first electrical plug which connects directly to said top receptacle and a second electrical plug which connects directly to said bottom receptacle. A first electrical cord extends from the first electrical plug and a second electrical cord extends from the second electrical plug. The first electrical cord and the second electrical cord each exit from the same side or a different side of the cover and separately end a desired distance away with a distal end at least the first of which has at least one receptacle at such distal end and the second of which also has at least one receptacle at its respective distal end or that distal end is, prepared for direct connection to a small appliance or electronic device. These first and second distal ends of said electrical cords can for example be positioned in the same or opposite directions or at perpendicular angles to each other or in opposite ends of the same room and afford enhanced versatility to the outlet covers described in U.S. Pat. Nos. 9,509,080 and 9,525,232.

At times it is desirable to dedicate an outlet to a specific appliance or electronic device but the outlet is not in the specific location desired for the specific appliance or electronic device, or the outlet needs to be covered to prevent access to infants and children, or the appliance or electronic device needs to be connected to the outlet and be flush against the wall adjacent to the outlet. Wiring the specific appliance or electronic device directly into the electrical wiring system in the building could perhaps meet these requirements, and certainly such hard-wiring is known for lighting fixtures such as sconces and ceiling lights. However, installation of such direct wiring is time consuming and typically requires engaging an electrician and accessing the wiring behind the wall which often requires cutting a hole in the wall that later has to repaired. Further, such installation is more permanent than plugging an appliance or electronic device into a wall outlet and does not afford the luxury of easily moving or replacing the wired appliance or device.

U.S. patent application Ser. No. 17/185,894, filed Feb. 25, 2021, pending, provides an indoor electrical wall outlet cover that provides a combination of advantages of plugging an appliance or electronic device into a wall outlet with advantages of electrically hard wiring the appliance, lamp, or electronic device directly into a wiring system, without the common disadvantages of each. In one embodiment of the invention described in the '894 patent application, the distal end of a cord of the electrical wall outlet cover is prepared for direct electrical connection exclusively to a small appliance or electronic device in a hardwired or quasi-hardwired fashion. That outlet cover has only such one cord and does not provide for use of a second or additional receptacle of the outlet. The outlet cover allows the small appliance or electronic device to be exclusively connected to the outlet, as if directly hardwired, but while still positioned a distance away from the outlet if desired.

The electrical connection component of the cover described in U.S. patent application Ser. No. 17/185,894 has an electrical cord attached thereto that extends downward from the electrical connection component out of the cover and falls generally flush against the wall and runs where desired to the small appliance, lamp, or electronic device to which the electrical cord is also connected, effectively “hardwired,” and thus at which the electrical cord ends.

As with the other functional indoor electrical wall outlet covers described above in referring to U.S. Pat. Nos. 9,509,080, 9,525,232, and 11,450,997, the electrical connection component described in U.S. patent application Ser. No. 17/185,894 has electrical pins bent at approximately ninety degree angles so that the connection of that component in the wall outlet receptacle does not add bulk or cause the cover to extend significantly beyond the outer surface of the electrical wall outlet so that furniture can be positioned in front of the outlet either against the wall or at least as close as the baseboard on the wall will allow.

The functional indoor wall outlet covers of U.S. Pat. Nos. 9,509,080, 9,525,232, 10,516,240, and 11,450,997, and U.S. patent application Ser. No. 17/185,894, each effectively cover the wall outlets so as to act as a safety device for a child that may seek to touch or access the outlet receptacles, while still allowing ready access to the electrical or coaxial connections that the outlet affords.

Moreover, these outlet covers are aesthetically pleasing—they are unobtrusive and call less attention to themselves than do the outlets without the covers of the invention. This is because the outlet covers, at least in certain embodiments described, are essentially or substantially blank, hide the receptacles of the outlets completely, and result in only one or two electrical cords or a coaxial cord extending from the outlet covers. That extension is intended to be in a manner where the cords lie against the wall or along the wall or less than about an inch from the wall, at least when proximate the outlet.

U.S. Pat. No. 10,516,240 adds that the coaxial cable extending from the functional indoor coaxial data outlet cover taught therein, and running along the wall adjacent thereto, can be affixed to the wall with a strong adhesive or cable clips affixed to the wall with a strong adhesive to further enhance the child safety aspect of the invention as well as the aesthetic neat and tidy appearance of the invention in use. There has continued to be a desire to improve such mechanisms for assuring that such coaxial cable or the electrical cord(s) extending from the functional indoor wall outlet covers always lie against the wall or along the wall or less than about an inch from the wall, particularly or especially when no longer closely proximate the outlet, for enhancing child safety and improving aesthetics.

Various cord clips and cable conduits and cord controllers are already known as are means for attaching cords and cables to walls and other supportive surfaces for holding, controlling and directing the cords and cables. Such means have varied from screw type fasteners to adhesive. There continues, however, to be a need for such control of cords extending from functional indoor wall outlet covers as described above that do not add bulk and obtrusiveness that defeat the thin, discrete, versatility and protection that these outlet covers provide.

### SUMMARY

The present invention provides a system for childproofing, effectively relocating, and/or aesthetically improving a functional indoor electrical cord wall outlet or coaxial data cable wall outlet while retaining use of the outlet. The system comprises a functional, indoor, electrical cord wall outlet or coaxial data cable wall outlet cover to hide or cover the respective electrical cord wall outlet or coaxial data cable wall outlet, such as described in U.S. Pat. Nos. 9,509,080, 9,525,232, 10,516,240, and 11,450,997, having at least one electrical cord or coaxial cable with a distal “plug” or connection end extending therefrom, or as described in U.S. application Ser. No. 17/185,894, except having an electrical cord extending from the wall outlet cover with an exclusive and direct wire or effectively “hardwire” type connection for a device or appliance, and at least one clip of the invention for affixing or otherwise securing said cord or cable to an adjacent wall.

The internal dimensions of the clip of the invention are uniquely and strategically sized and shaped to an identical “match,” complementing or corresponding to the each and all of the external dimensions of the electrical cord or coaxial data cable in a manner that the cord or cable is held tightly by, secured with, immovable within the clip's internal channel of, the invention so as not to be accessed or removable by children, and discretely, that is, with a low profile and without any outward projection or horizonal trajectory extending south or towards the floor, so as not to call attention to itself or the cord or cable and to prevent any tripping or other safety hazards. The inner channel or interior of the clip of the invention thus “matches” the external dimensions or exterior of the cord or channel the clip is holding to effect these advantages of the invention, when the clip has an inner channel or interior that conforms to the external dimensions of the electrical cord or coaxial cable, including with respect to height and curvature.

The adhesive of the external bottom of the clip of the invention is comprised of high-strength and long-lasting bond made from an acrylic polymer material or similar material which creates a very strong flexible bond between two surfaces. The adhesive of the external bottom of the clip of the invention when affixed to the wall for holding the cord or cable extends from the adjacent wall no more than about one-half inch to about one and one-half inches with one inch being typical for electrical cord clips and one-half inch being typical for coaxial cord clips. The adhesive of the external bottom of the clip of the invention receives and holds the cord or cable flat or substantially flat and/or firmly against the adjacent wall (or other support), preferably from the outlet cover to the desired location for use of the functional end of the cord or cable which is distal the outlet cover. Securing the cord or cable to the wall (or other support) in this manner directs the path of the cord or cable for a controlled and aesthetically neat appearance and avoids the cord or cable appearing tangled or becoming a tripping hazard. Securing the cord or cable to the adjacent wall (or other support) also deters tampering with or chewing of the cord or cable by babies, children, and pets. The clip is affixed to the wall in one embodiment by an affixer, preferably removable, such as for nonlimiting example an adhesive or a removable adhesive.

The length of the clip of the invention can vary as desired for the use and length of the cord or cable. Multiple smaller clips, such as, for nonlimiting example, about one inch to about five inches in length, provide versatility in one illustrative embodiment. A single longer clip, approaching the length of the cord or cable for another nonlimiting example can be useful in another illustrative embodiment. Straight clips are effective for positioning and directing a cord or cable along a straight path and curved clips are effective for neatly turning a cord or cable from one path to a path in a different direction while causing the cord or cable to remain firmly and neatly secured or close or proximate to an adjacent wall. In one embodiment for childproofing, a series of longer, closely spaced clips, are used to effectively cover most or substantially all of the cord or cable running along the wall. The longer sized clips of the invention are specifically intended for childproofing applications because they are sufficiently long to reduce or eliminate the risk of a choking hazard for infants and children.

The present invention further provides these clips for use in the method of the invention as well as for the system of the invention. The method of the invention provides steps for childproofing an electrical or coaxial data wall outlet while also rendering the outlet more aesthetically pleasing. In that method, a functional indoor electrical wall outlet cover, or a functional indoor axial data wall outlet cover, is plugged or otherwise connected into a respective electrical wall outlet or a coaxial data wall outlet, where the outlet cover effectively covers the outlet, hiding the receptacles completely, to act as a safety device for a child that may seek to touch or access the outlet receptacles. Such outlet cover is also aesthetically pleasing—it is unobtrusive and calls less attention to itself than the wall outlet without the outlet cover—the outlet cover being less than about an inch in thickness, covering the outlet completely and having a generally blank face with the electrical outlet cover showing no screws on its face and the coaxial wall outlet cover showing no more than a couple of screws on its face.

Further, these respective outlet covers have extending therefrom only one or two respective associated electrical cord (or cords) or coaxial (or data) cable (or cables), which have at their respective distal end (or ends) from the wall outlet at least one electrical plug (or electrical “hardwire”-type direct wire connection) or a coaxial (or data) connection component. Such plug(s) or connection component(s) effectively moves the functionality of the wall outlet to said distal end(s).

In the method of the invention, the distal end(s) of the electrical cord(s) or the axial cable(s) extending from the respective outlet cover(s) is routed in a desired direction and/or along a desired path to the desired location for use of the electrical or coaxial data functionality in that distal end. Clips of the invention are used to firmly and neatly secure the cord(s) or cable along said route along an adjacent wall or other support to provide a neat or tidy look that prevents tangling of the cord(s) or cable(s), prevents the cord(s) or cable(s) from becoming a tripping hazard, and deters and/or prevents children and pets from tampering or chewing the cord(s) or cable(s), thereby effectively further childproofing the wall outlet beyond the protection afforded by the outlet cover itself.

### BRIEF DESCRIPTION OF THE DRAWINGS

The present invention will be better understood by referring to the following detailed description of preferred embodiments and the drawings referenced therein, in which:

FIG. 1 is a prior art, front perspective view (for illustration and not drawn to scale) of a typical electrical wall outlet with two electrical cords protruding therefrom, as is common in appearance in the prior art.

FIG. 2 is an illustrative example (not drawn to scale) of one embodiment of the system of the invention, in a front perspective view, where two electrical cords extending from a functional indoor electrical wall outlet cover (over a functional indoor electrical wall outlet) are held in place on the adjacent wall by curved clips and straight clips of the invention.

FIG. 3 is a prior art, front perspective view (for illustration and not drawn to scale) of a typical coaxial data wall outlet with a coaxial data cable protruding therefrom, as is common in appearance in the prior art.

FIG. 4 is an illustrative example (not drawn to scale) of another embodiment of the system of the invention, in a side perspective view, where a coaxial data cable extending from a functional indoor coaxial wall outlet cover (over a functional indoor coaxial wall outlet) is held in place on an adjacent wall by a curved clip and a straight clip of the invention.

FIG. 5 is a front perspective view of the embodiment of the system of the invention shown in FIG. 4.

FIG. 6 is a perspective view of a straight electrical cord clip of the invention that is used in an embodiment of the system of the invention for childproofing and aesthetically improving an electrical wall outlet, where the clip is about one inch in length.

FIG. 7 is a perspective view of a straight electrical cord clip of the invention that is used in an embodiment of the system of the invention, which is like the clip shown in FIG. 6 except longer, about four inches in length.

FIG. 8 is a perspective view of a straight electrical cord clip of the invention that is used in an embodiment of the system of the invention, which is like the clips shown in FIGS. 6 and 7 except longer, about five inches in length.

FIG. 9 is an end view of the straight electrical cord clips shown in FIGS. 6, 7, and 8; an end view of the curved electrical cord clip of FIGS. 18 and 19 would look similar.

FIG. 10 is a perspective view of an alternative straight electrical cord clip of the invention that is used in a second embodiment of the system of the invention for childproofing and aesthetically improving electrical wall outlets, which is substantially like the clip shown in FIG. 6 except for use with a wider cord, such as a surge cord or an SPT-3 cord.

FIG. 11 is an end view of the straight electrical cord clip of FIG. 10; the end view of the curved clip of FIGS. 20 and 21 would look similar.

FIG. 12 is a mouth side view of the electrical cord clip of FIGS. 10 and 11, which is the side where the cord is inserted into the clip.

FIG. 13 is a front view of the straight electrical cord clip of FIG. 6 shown clipped around an electrical cord.

FIG. 14 is a front perspective view of another alternative straight electrical cord clip of the invention that is used in a third embodiment of system of the invention, where the clip is about three inches in length and has a straight closed side, shown clipped around a section of an electrical cord.

FIG. 15 is a mouth side perspective view of the straight electrical cord clip of FIGS. 6 and 13, shown clipped around a section of an electrical cord.

FIG. 16 is a mouth side perspective view of the straight electrical cord clip of FIG. 14, shown clipped around a section of an electrical cord.

FIG. 17 is a perspective end view of the straight electrical cord clip of FIG. 16 with the electrical cord cut away at that end to show the interior of the cord; the interior of the cord in an end view of the straight clip of FIG. 15 (with the cord cutaway) would look similar.

FIG. 18 is a front and mouth side perspective view of a curved electrical cord clip of another embodiment of the clips of the invention, which is about three inches in overall length, and used in an embodiment of the system of the invention for childproofing and aesthetically improving electrical wall outlets, with the same size cord with which the straight electrical cord clips of FIGS. 6, 7 and 8 are used.

FIG. 19 is a top view of the curved electrical cord clip of FIG. 18.

FIG. 20 is a front and mouth side perspective view of a curved electrical cord clip, of still another embodiment of the clips of the invention, which is about three inches in overall length, used in another embodiment of the system of the invention for childproofing and aesthetically improving electrical wall outlets, with the same size cord with which the straight clip of FIGS. 10, 11 and 12 is used.

FIG. 21 is a top view of the curved electrical cord clip of FIG. 20.

FIG. 22 is a top perspective view of the curved electrical cord clip of FIG. 18, shown clipped around a section of electrical cord.

FIG. 23 is an end perspective view of the curved electrical cord clip of FIG. 22, but with an adhesive strip on the back, and with the electrical cord cut away at that end to show the interior of the cord.

FIG. 24 is a perspective top and mouth side view of a straight coaxial cable clip of the invention used in an embodiment of the system of the invention for childproofing and aesthetically improving coaxial (or data) wall outlets, wherein the coaxial cable clip is about one inch in length.

FIG. 25 is an end view of the straight coaxial cable cord clip of FIG. 24; the end view of the curved coaxial cable cord clip of FIG. 27 will be similar.

FIG. 26 is a mouth side view of the straight coaxial cable cord clip of FIGS. 24 and 25.

FIG. 27 is a perspective mouth and top side view of a curved coaxial cable cord clip of the invention used in an embodiment of the system of the invention for childproofing and aesthetically improving coaxial (or data) wall outlets, wherein the coaxial cable clip is about three inches overall in length.

FIG. 28 is a top view of the curved coaxial cable cord clip of FIG. 27.

FIG. 29 is an illustrative example (not drawn to scale) of another embodiment of the system of the invention, where one electrical cord extends from a functional electrical wall outlet cover (over an electrical wall outlet) and is held in place on the adjacent wall by curved clips and one-inch straight electrical cord clips of the invention.

FIG. 30 is an illustrative example (not drawn to scale) of still another embodiment of the system of the invention, where one electrical cord extends from a functional electrical wall outlet cover (over an electrical wall outlet) and is held in place on the adjacent wall by four-inch and five-inch straight electrical cord clips of the invention substantially covering the cord.

Reference Numerals in the Drawings
10 1 inch straight electrical cord clip
11 functional indoor electrical outlet cover
12 4 inch straight electrical cord clip
13 planar front side of straight electrical cord clip of the invention
14 5 inch straight electrical cord clip
15 planar back side of straight electrical cord clip of the invention
16 3 inch straight electrical cord clip (alternative embodiment of cord clips 10, 12, 14)
17 mouth side of electrical cord clips 10, 12, 14, 16, 18
18 3 inch curved electrical cord clip
19 end of electrical cord clips 10, 12, 14, 18, open and leading to channel or tube-like interior 25
20 electrical cord extending from functional indoor electrical outlet cover
21 closed & curved (or arced) side of electrical cord clips 10, 12, 14
22 live conductor in electrical cord 20
23 concave, narrow or slit “V” shaped opening on mouth side 17 of electrical cord clips 10, 12, 14, 16, 18 pointing toward interior of cord clip
24 neutral conductor in electrical cord 20
25 interior of electrical cord clips 10, 12, 14, 16, 18
26 earth (or ground) conductor in electrical cord 20
27 exterior side edges of the planar front side 13 of the electrical cord clips 10, 12, 14
28 exterior side edges of the planar back side 15 of the electrical cord clips 10, 12, 14
29 adhesive strip(s)
30 coaxial cable extending from functional indoor coaxial data outlet cover
31 functional indoor coaxial data outlet cover
33 straight electrical cord clip for wide cord such as surge or SPT-3 cord
35 1 inch straight coaxial cable cord clip
36 end of coaxial cable cord clip, open and leading to channel or tube like interior 45 or 47
37 3 inch curved coaxial cable cord clip
38 curved front of straight coaxial cable cord clip
39 planar back of straight coaxial cable cord clip
40 closed side of straight coaxial cable cord clip
41 “C”-shaped opening (on mouth side) of straight coaxial cable cord clip
42 curved front of curved coaxial cable cord clip
43 planar back of curved coaxial cable cord clip
44 mouth side of curved coaxial cable cord clip
45 interior of curved coaxial cable cord clip
46 closed side of curved coaxial cable cord clip
47 interior of straight coaxial cable cord clip
50 wall
51 electrical wall outlet
52 coaxial wall outlet
53 prior art electrical cord
54 prior art coaxial cord
55 curved electrical cord clip for wide cord such as surge or SPT-3 cord
170 mouth side of electrical cord clip 33
180 planar curved front side of curved electrical cord clip 18
185 planar curved back side of curved electrical cord clip 18
1800 planar curved front side of curved electrical cord clip 55
190 end of electrical cord clip for heavier/wider electrical cord extending from functional indoor electrical outlet cover, similar to end of electrical cord clip 19 but wider
320 interior of electrical cord clip for heavier/wider electrical cord extending from functional indoor electrical outlet cover, similar to interior of electrical cord clip 25 but wider
210 closed, straight side of electrical cord clip 16
230 concave, narrow or slit “V” shaped opening on mouth side 170 of electrical cord clip pointing toward interior of the cord clip 33
2100 closed side of electrical cord clip for heavier/wider electrical cord extending from functional indoor electrical outlet cover, similar to interior 25 of electrical cord clip 10 but wider

In the Figures and the illustrative examples discussed with respect to some embodiments of the invention, the same reference numerals may be used in more than one Figure. This reuse of a reference numeral in different Figures represents the same element in the different Figures, even though the Figures may illustrate different embodiments of the invention, indicating that such embodiments, albeit different, have some common or like elements.

### DETAILED DESCRIPTION

The present invention provides a system and method for childproofing and/or aesthetically improving an indoor electrical or coaxial wall outlet while retaining use of the outlet. The system includes an a functional, indoor, electrical or coaxial, wall outlet cover which respectively has at least one functional electrical cord or coaxial cable extending from it and at least one respective electrical plug or connection, or coaxial connection component, at the end of that cord or cable distal the wall outlet cover, for effectively moving the functionality of the wall outlet to another desired location through that cord or cable. The functional wall outlet covers of U.S. Pat. Nos. 9,509,080, 9,525,232, 10,516,240, and 11,450,997, and U.S. patent application Ser. No. 17/185,894, all of Insalaco and briefly discussed above, are particularly suited for use in the system of the present invention.

As used in the system of the present invention, the wall outlet cover substantially aesthetically improves the appearance of the wall outlet by covering it. The wall outlet cover of the system is sufficiently thin that it protrudes from the wall less than the depth of a typical electrical plug, that is, less than about an inch, and without adding any significant bulk to the wall outlet. The wall outlet cover is also so thin that furniture can be positioned in front of or adjacent to the outlet and essentially flush with, i.e., less than about an inch away from, the wall on which the outlet is located, or at least as close to the wall as any baseboard on the wall permits. The wall outlet cover fully conceals the wall outlet and particularly conceals and shields the openings or receptacles in the outlet from access by children. Further, the wall outlet cover does not call attention to itself, as the wall outlet cover for electrical outlets is blank, and the wall outlet cover for coaxial wall outlets is blank except for in some embodiments a couple of screw heads. In this manner the wall outlet is aesthetically pleasing to adults and not attractive, interesting, or noticeable to children.

The wall outlet cover has at least one, and at the most two, electrical cord(s) or coaxial cable(s) extending from it and that cord or cable has a depth or perimeter less than any plug at the end of the cord and less than or about the same thickness as the outlet cover. Such cord or cable is preferably of sufficient length to allow effective movement of the functionality of the wall outlet through the cord or cable to a desired location, and can typically, for non-limiting example in one embodiment, range in length from about three feet to about thirty feet. This cord or cable effectively moves the functionality location of the wall outlet to the distal end of the cord or cable, enabling the user to provide that location away from the reach of children and/or pets or in a more convenient place than the wall outlet location.

In one embodiment of the invention, the electrical cord that is associated with and extends from the functional indoor electrical wall outlet cover in the system of this invention is a thin, flat shaped SPT (Stranded, Parallel, Thermoplastic)-2 (installation thickness), 16 AWG (American Wire Gauge), 3 core multi-conductor electrical cord. In another embodiment of the invention, the electrical cord is a thin, flat shaped, SVT (Service Vacuum Thermoplastic), 16 AWG, 3 core multi-conductor electrical cord. In still another embodiment of the invention, the electrical cord could is a thin, flat shaped SJT (Service Junior Thermoplastic), 16 AWG, 3 core multi-conductor electrical cord.

In further embodiments of the invention, a thicker (but still thin), flat shaped SPT-3, SVT, or SJT, 14 AWG, 3 core electrical cord is associated with and extends from the outlet cover that is used in the system of the invention. In these embodiments, the electrical cords are 3 core cords, comprised of live, neutral and earth conductors. These cords are also typically striated along the outer insulation.

Still further, in another embodiment of the invention, the electrical cord used in the invention is a circumferentially round shaped electrical cord, having the following dimensions: SPT-2, SPT-3, SVT or SJT, 14 or 16 AWG, and is a 3 core multi-conductor electrical cord.

For another example, in a further alternative embodiment of the system of the invention, a circumferentially round shaped coaxial data cable is associated with and extends from the functional indoor coaxial data outlet cover used in the system of this invention. This coaxial data cable is an outer installation coaxial cable ranging from about 0.24 inch to about 0.50 inch in diameter.

However, the present invention is not designed for, nor is it intended for use with or compatible with, a multi-conductor electrical cord having less than or more than 3 cores. The present invention is not designed for, nor is it intended for use with or compatible with, an electrical cord having an installation thickness less than SPT-2 or greater than SPT-3.

The present invention is not designed for, nor is it intended for use with or compatible with, Americanwire gauge of less than 12 (12 AWG) or greater than 18 (18 AWG). The present invention is not designed for, nor is it intended for use with or compatible with, an electrical cord having a maximum amperage capacity of 16, a maximum volts capacity of 300 and a maximum wattage capacity of 1,920. The present invention is also not designed for, nor is it intended for use with an outdoor electrical cord or an outdoor data cable.

The system of the invention further includes at least one clip of the invention “matching” or complementing each said electrical cord or coaxial cable extending from the outlet cover. Such “matching” is obtained when the inner channel or interior of the clip of the invention conforms to the external dimensions of the electrical cord or coaxial cable the clip will hold in the invention. Such external dimensions of the electrical cord or coaxial cable are described in the preceding paragraphs above.

The clip(s) of the invention receives and holds the cord(s) or cable firmly in place adjacent the wall proximate the wall outlet. Such clips have a thinness similar to that of the outlet cover and the cords or cable and thus the clips of the invention protrude from the wall a minimal amount, about one-half inch to about one inch, with one inch or less being typical for electrical cord clips and one-half inch being typical for coaxial cord clips. The clips, like the outlet cover, do not call attention to themselves and have a blank face that is aesthetically pleasing but that is not noticeable, attractive or interesting to children. The clips are themselves affixed to the wall by a removable affixer such as for non-limiting example an adhesive comprised of high-strength and long-lasting bond made from an acrylic polymer material or similar material which creates a very strong flexible bond between two surfaces. Other strong, removable adhesives (but not easily removable by children) or a chemical equivalent or another known substitute for such adhesive for such affixing purpose could alternatively be used.

The clips of the invention each have an internal or interior perimeter that corresponds in size to, and in some embodiments conforms to, complements or “matches” the exterior perimeter and/or shape of the cord the clip will hold. Thus when the clip of the invention grips or surrounds the cord or cable, the cord or cable fits snugly or firmly against the interior of the clip, and in some embodiments, in a complementary or “matching” manner, so that the cord or cable is not easily or inadvertently removed from the clip. Thus, each clip is capable of holding the cord or cable, or at least a section of the cord or cable, firmly against or proximate a wall or other desired support for the cord or cable, thereby avoiding tampering or chewing of the cord or cable by a child or pet, and also allowing for a planned, directional path for the cord or cable on the wall or other support for a neat and/or aesthetically pleasing appearance. Such holding, supporting, and control of the cord also can prevent tangling of the cord or cable, or a loose cord or cable, that could cause a tripping hazard.

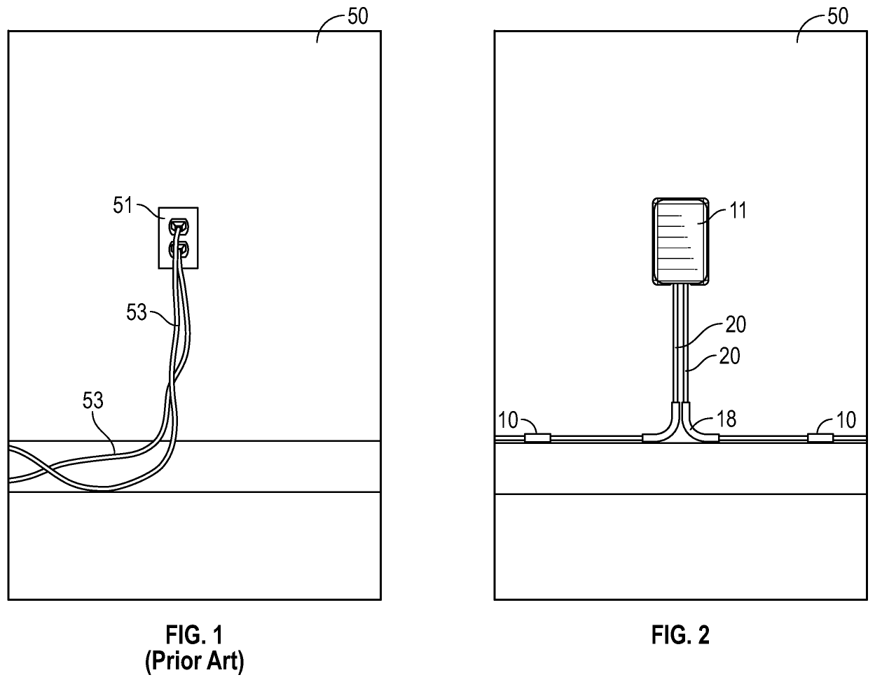

Referring to the Figures, a comparison of FIGS. 1 and 2 illustrates an example of these advantages of the system of the invention, with FIG. 2 showing a functional indoor electrical wall outlet cover 11 in place (over a wall outlet 51) with curved clips 18 and straight clips 10 of the invention affixed to the wall 50 holding and neatly routing the electrical cords 20 extending from the outlet cover 11, in contrast to the messy looking, free-dangling prior art electrical cords shown in FIG. 1.

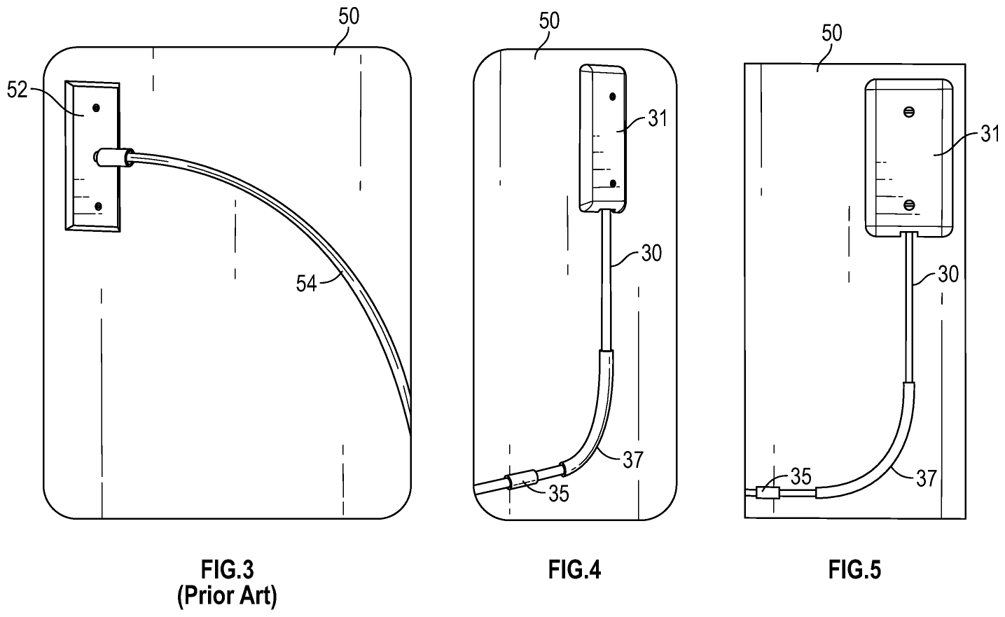

Comparison of FIGS. 3-5 illustrate another example of the advantages of the system of the invention with FIGS. 4 and 5 showing a functional indoor coaxial wall outlet cover 31 of the system of the invention in place with curved clips 37 and straight clips 35 of the invention holding and routing a coaxial cable 30 extending from the outlet cover 31 closely against the wall 50, in contrast to the noticeable outward protrusion of the prior art coaxial cable 54 shown in FIG. 3.

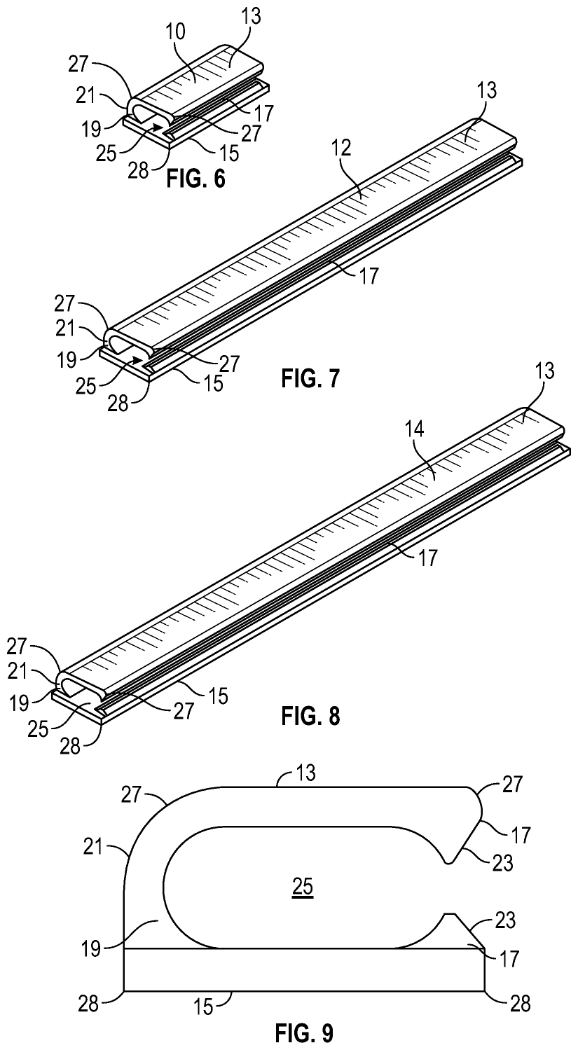

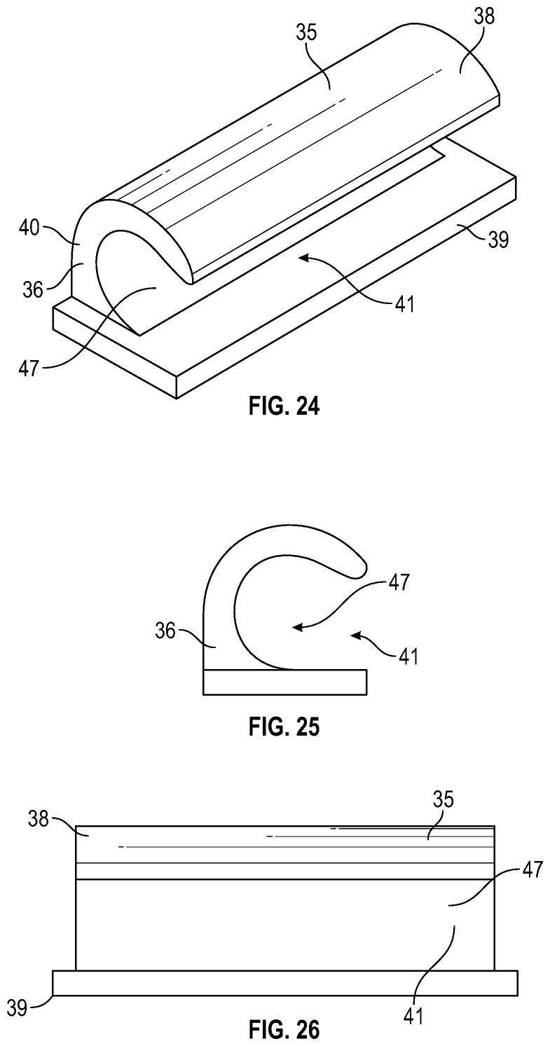

The length of the straight clips, the need for curved clips, and the number of clips overall used in a system of the invention depends on the length of the cord or cable and the desired path for the cord or cable. FIGS. 6, 7, and 8 show three non-limiting examples of lengths for respective straight electrical cord clips 10, 12, and 14 of an embodiment of the clip of the invention, one inch, four inches and five inches in length respectively, and FIG. 16 shows a three inch example of a straight electrical cord clip 16 of an alternative embodiment. FIG. 24 shows a one-inch example of a coaxial cable clip 35 of another embodiment of the invention. The clips of the invention can be longer than these examples from different embodiments—even extending as much as a foot or more or even so long as approximating the cord or cable length. Multiple smaller clips, such as one-inch clips, however, often afford more flexibility in various placements and directions of a cord or cable.

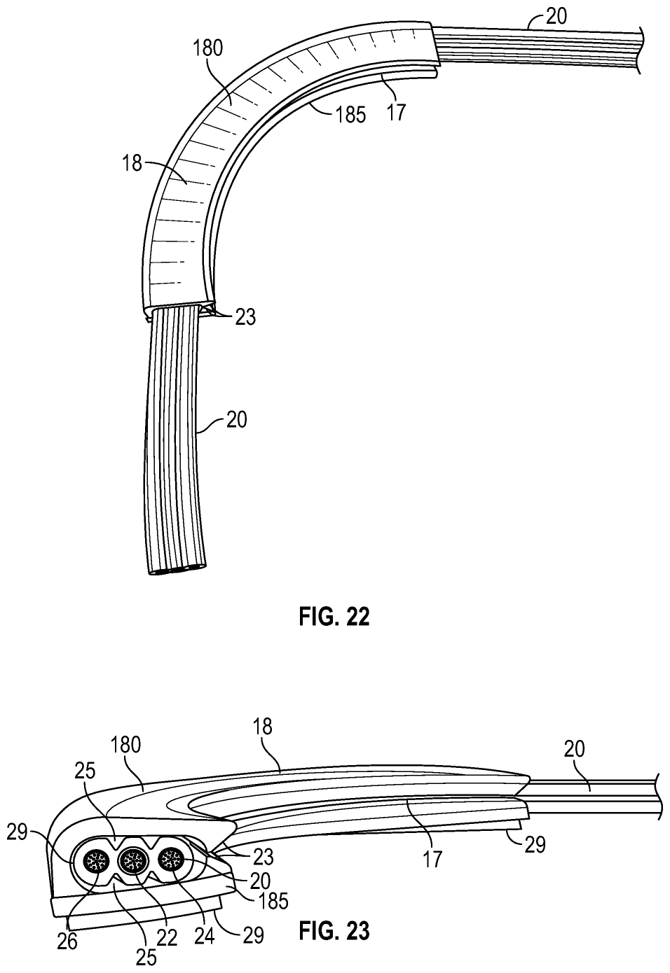

The clips of the invention are in one embodiment comprised of a stiff, resilient plastic or polymer material, such as rigid polyvinylchloride or similar polymer for example, which can preferably be extruded so that the clips can each be easily and economically made in one piece by extrusion. If the clips are each made in more than one piece, the pieces should be readily heat welded or combined in a similar manner for use as one piece. When formed to the general or approximate configurations shown in the Figures and described herein, the clips of the invention provide a sufficiently rigid structure for firmly and neatly holding the cord or cable securely so that tampering by a child is deterred while the clip openings are still sufficiently resiliently deformable that an adult can insert or remove the cord or cable or otherwise “clip” the clip of the invention to the cord or cable or have the clip of the invention grip or hold the cord or cable, as shown in FIGS. 13-17 and 22.

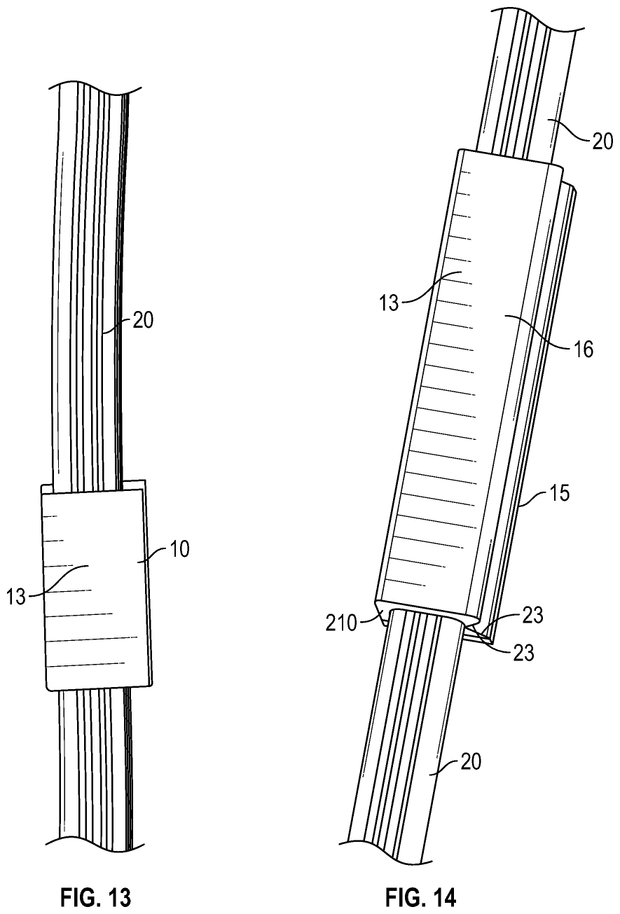

FIGS. 6 through 17 illustrate example configurations of straight electrical cord clips of the invention, for use in the system and method of the invention. In the embodiments illustrated, the clips of the invention are configured to correspond to and to “match” or complement the cords they will hold. For the desired minimal profile of the functional indoor outlet covers of the invention, that is, minimal protrusion from the wall, the electrical cords that extend from the functional indoor electrical outlet covers have minimal thickness and a thickness that is less than or no greater than the thickness of the outlet covers, which are previously noted is less than an about an inch in depth or thickness. The electrical cords are also preferably relatively flat and as previously noted less than about an inch in thickness. The electrical cord clips are therefore likewise, relatively flat in external appearance and less than about an inch in thickness.

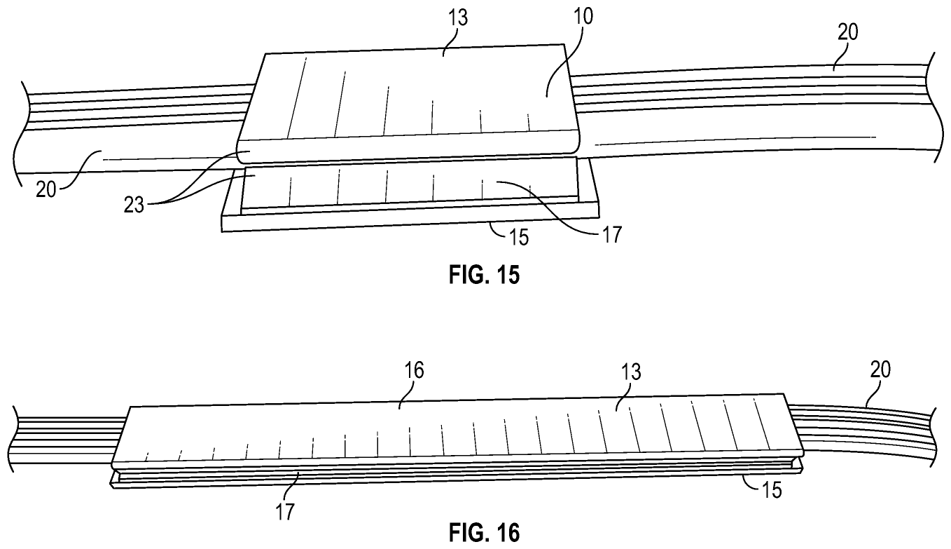

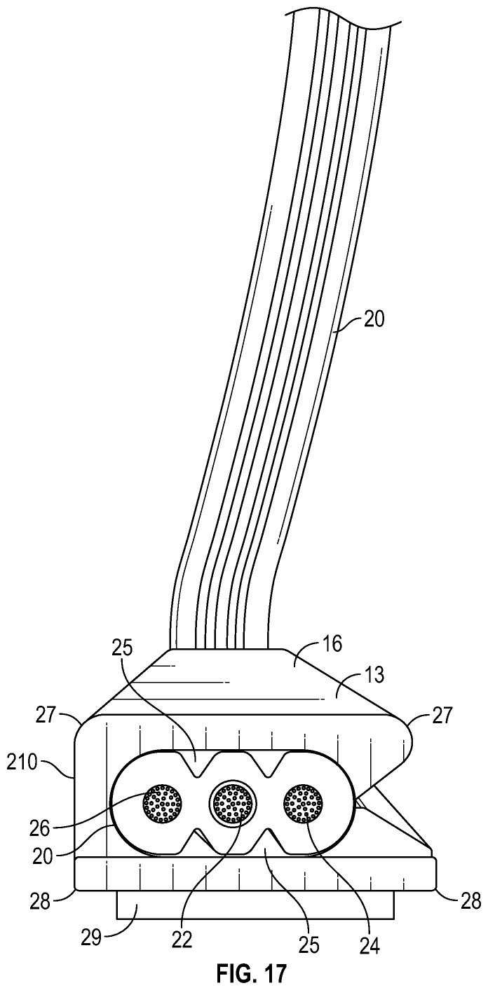

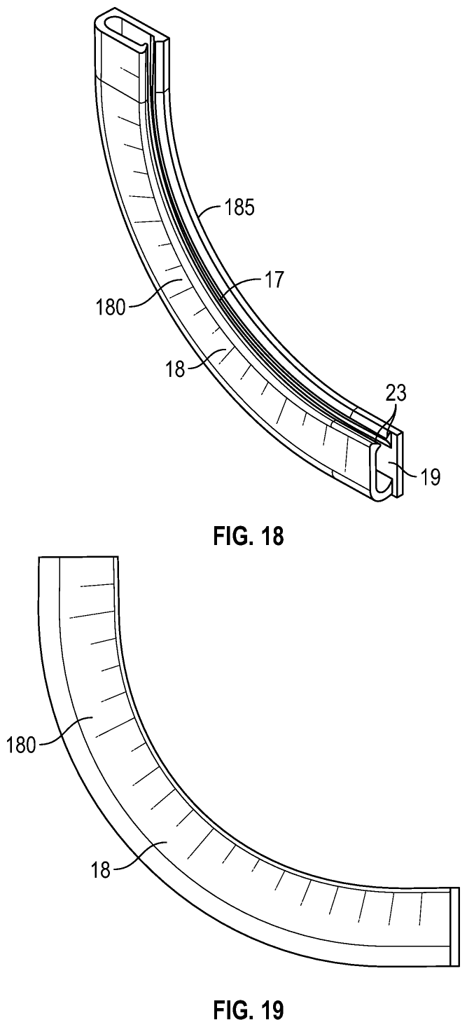

The electrical cord clips 10, 12, and 14 (respectively shown in FIGS. 6, 7, and 8) of the invention, for an SPT-2 electrical cord 20, differ only in length as discussed above, for an electrical cord 20 (having a live conductor 22, neutral conductor 24 and earth (or ground) conductor 26 fitted side by side as shown in FIGS. 17 and 23). These electrical cord clips 10, 12, and 14, similar to clip 16 (shown in FIGS. 16 and 17), each have a planar front side 13 positioned parallel to a planar back side 15, joined together by closed side 21 (or closed side 210 for clip 16). In one embodiment the planar back side 15 can be slightly longer and/or wider then the planar front side 13, as shown in FIG. 15, to allow more surface area for an adhesive or other affixer to affix the clip to a wall 50 or other supporting surface. An adhesive strip 29 is shown on clip 16 in FIG. 17, but not on clip 16 as shown in FIG. 16 (and on clip 18 in FIG. 23 but not in FIG. 18). The side of the clips 10, 12, and 14 that opposes closed side 21 (or closed side 210 of clip 16), is mouth side 17, which is capable of tightly and removably receiving the electrical cord 20.

As shown in several of the Figures, mouth side 17 has a concave, narrow or slit opening 23 pointing toward the hollow channel or tube-like interior 25 of the clip to facilitate receiving of the electrical cord 20 into the interior 25 of the clip and resisting removal of the electrical cord 20 by children or pets. The opposing closed side 21 (or 210) of the electrical cord clip is closed (to join the planar front side 13 and planar back side 15 for the hollow, flat channel or tube-like interior 25 with open ends 19), and can be generally straight (with approximate ninety degree angles where joining the planar front side 13 and planar back side 15 as shown for side 210 in FIG. 17, or can be curved outwardly slightly or convexly, for example, approximately matching the corresponding external side 29 (shown in FIGS. 17 and 23) of the cord 20 as shown for side 21 in FIGS. 6-9.

In some embodiments as shown in FIGS. 6-11 and 17, the exterior edges of the planar front side 27 of the clip are curved for safety and for a neat, minimal and unobtrusive appearance, while the exterior edges of the planar back side 28 of the clip approximate ninety degrees where joining with sides 19 and 21 to better accommodate adhesive or one or more adhesive strip(s) 29, which can be typically square or rectangular (as shown in FIG. 17). In most embodiments, the clip is affixable to the wall 50 or other supporting surface for the electrical cord 20, preferably with a strong but removable adhesive or adhesive strip 29 on the exterior of the planar back side 15 of the clip.

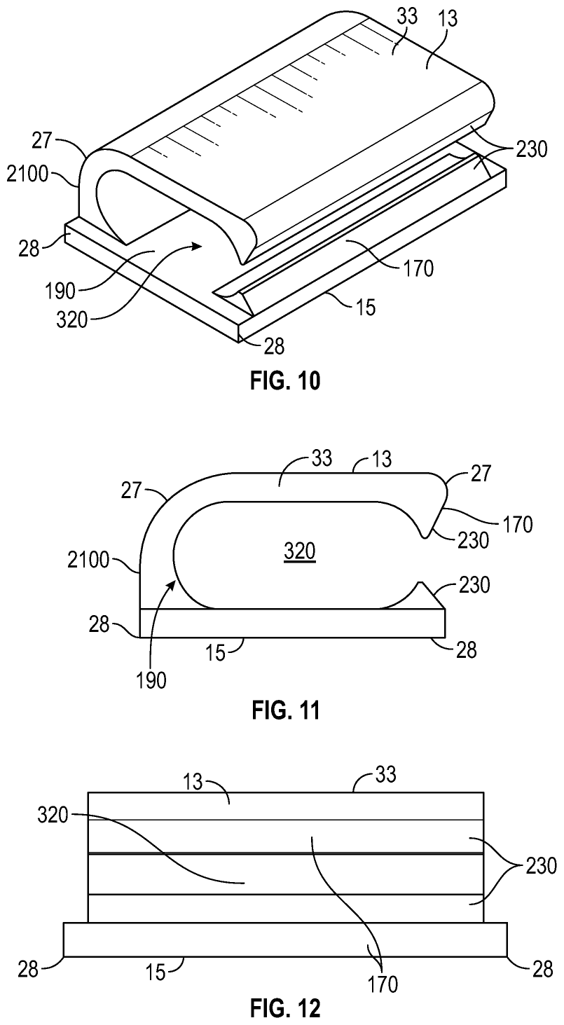

FIGS. 10-12 show another example embodiment of a straight electrical cord clip 33 of the invention that is substantially like the straight electrical cord clips 10, 12, 14, and 16 except that clip 33 is configured for a heavier or wider electrical cord, such as a SPT-3 cord or a surge cord. Thus, mouth side 170 and opposing, closed side 2100 of clip 33 and ends 190 are taller or higher to accommodate that larger electrical cord 20 within the interior 320.

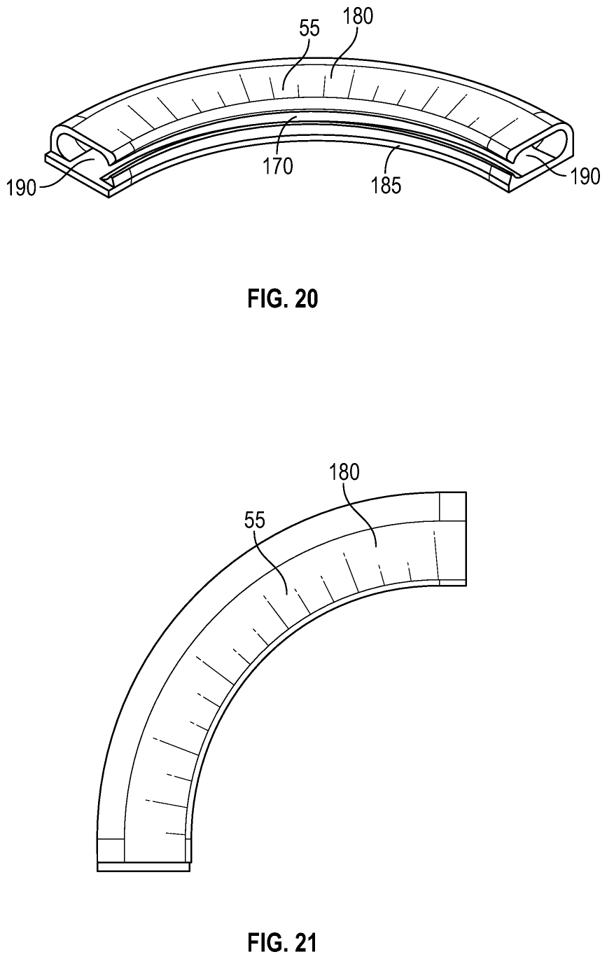

The features discussed above with respect to illustrative examples of the embodiments of straight electrical clips 10, 12, 14, and 16 illustrated in FIGS. 6-9 and 13-17 also generally apply to the embodiment of curved electrical clip 18 of the invention, for a SPT-2 cord, illustrated in FIGS. 18, 19, 22 and 23. Similarly, the features discussed above with respect to illustrative examples of the embodiments of straight electrical cord clip 33 of the invention, for a SPT-3 cord, illustrated in FIGS. 10-12 also generally apply to the embodiment of curved electrical clip 55, illustrated in FIGS. 20 and 21.

With the curved clips, the mouth side 17 is not as long as the opposing closed side so as to enable the curve, giving the curved clip a more quarter circle shape, rather than the more rectangular shape of the straight clip overall. However, the curved clips have a planar front side 180 parallel to a planar back side, a “V” shaped mouth 23, a flat, channel or tube-like interior, and open ends 19; and curved clip 55 is taller or higher than curved clip 18.

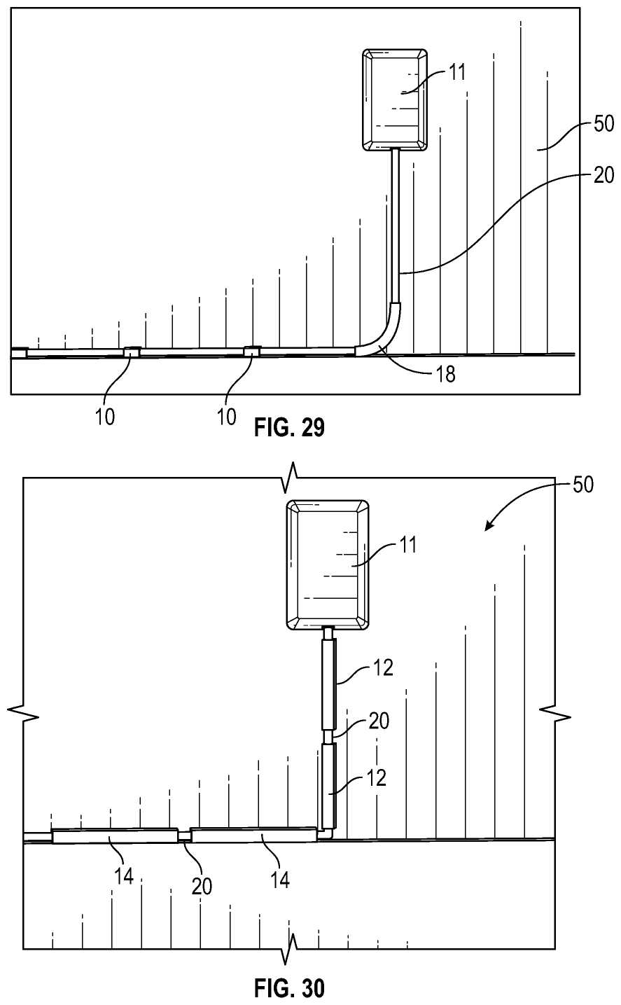

In one embodiment of the invention, the system comprises at least one straight clip and at least one curved clip of the invention. The curved clip allows smooth turning and change of direction of the cord, for example, from a vertical direction to a horizontal direction, as shown for example in FIGS. 2, 4, 5, and 29, while maintaining the cord tightly affixed to the wall or other supporting surface and without bending or crimping the cord. Bending a cord as shown in FIG. 30 can be practiced effectively with some electrical cords although it is not recommended or possible for others, such as coaxial cables.

The following provides example dimensions of one illustrative example embodiment of an electrical cord clip of the invention, suitable for use with a SPT-2 electrical cord, as shown as clip 10 in FIGS. 6 and 9. As shown in FIG. 6, the planar back side 15 in this example is about 1.118 inches in length and the planar front side 13 is about 1.000 inch in length. The gap created by the “V”-shaped opening 23 as shown in FIG. 9 is about 0.072 inches high; the clip 10 height overall is about 0.290 inches, and the clip 10 interior height is about 0.165 inches. Further in this example, when the clip 10 is straight as shown in FIG. 6, the length of clip 10 overall is about one inch. The planar back side 15 and the planar front side 13 can be longer—even as extending as much as a foot or more in length—as shown in FIGS. 7, 8 and 30. However, using multiple clips as shown, for example, in FIG. 29, affords more flexibility for various placements and directions of the cord in some embodiments. Using longer clips, as shown, for example, in FIG. 30, can be preferred for child protection in some embodiments.

For another example, electrical cord clip 18 of the invention, as shown in FIGS. 18 and 19 (and 22 and 23) is similar to clip 10 with respect to appearance (except for curve), features, size (except length) and cord size accommodation. Clip 18, in this example, has a one quarter circle turn (or curve) as shown in FIGS. 18 and 19. The external radius of the curve is about 2.541 inches and the internal radius of the curve is about 1.970 inches. The overall width of curved clip 18 is about 3.000 inches and the overall length of curved clip 18 is about 3.000 inches. This size curve allows a gradual turning of the cord path which is both aesthetically pleasing and achievable for nearly all cords without causing any crimping or other damage to the cord. The height of clip 18 is like the height of clip 10.

The following is an example of dimensions of another alternative embodiment of an electrical cord clip of the invention, suitable for use with a SPT-3 electrical cord, as shown as clip 33 in FIGS. 10-12. Referring to FIG. 10, the planar back side 15 of clip 33 is, for example, about 1.118 inches in length and the planar front side 13 is about 1.000 inch in length. Referring to FIG. 9, the gap created by the “V”-shaped opening 23 is about 0.107 inches high; the clip 33 height overall is about 0.397 inch, and the clip 33 interior height is about 0.261 inches. Further in this example, when the clip 33 is straight as shown in FIG. 10, the length of clip 33 is about one inch. The planar back side 15 and the planar front side 13 of clip 33 can be longer—even as extending as much as a foot or more in length—as with clip 10 in the previous example.

For still another example, electrical cord clip 55 of the invention, as shown in FIGS. 20 and 21, is comparable to electrical cord clip 33 with respect to appearance (except for curve), features, size (except length) and cord size accommodation, being sized for use with a SPT-3 electrical cord. Clip 55, in this example, has a one quarter circle turn (or curve) as shown in FIGS. 20 and 21. The external radius of the curve is about 2.756 inches and the internal radius of the curve is about 2.012 inches. The overall width of curved clip 55 is about 2.967 inches and the overall length of curved clip 55 is about 3.006 inches. As with clip 18, this size curve allows a gradual turning of the cord path which is both aesthetically pleasing and achievable for nearly all cords without causing crimping or other damage to the cord.

The principals and features described above for a system of the invention where the outlet cover is for an electrical wall outlet generally apply as well for a system of the invention where the outlet cover is for a coaxial data wall outlet, except that the cord is a coaxial cable instead of an electrical cord. That is, referring to FIGS. 4, 5, and 24-28, for a system of the invention where the wall outlet is a coaxial data wall outlet, the functional indoor coaxial wall outlet cover particularly suited for use in the system is described in U.S. Pat. No. 10,516,240. This outlet cover conceals or hides the coaxial wall outlet and has extending from it a coaxial cable to effectively move the functionality of the coaxial wall outlet to the distal end of that cable. Coaxial data cable clip(s) of the invention are used in the system to neatly guide the coaxial cable to the desired destination or location for use of that coaxial wall outlet functionality in that distal end.

As with the clip of the invention for an electrical cord, the clip of the invention for a coaxial cable can be straight or curved, as shown respectively in FIGS. 24 and 27-28. In one embodiment of the invention, the system comprises at least one straight coaxial data cable clip and at least one curved coaxial data cable clip. The curve allows smooth turning and change of direction of the cable, for example, from a vertical direction to a horizontal direction as shown for example in FIGS. 4 and 5, while holding the cable firmly against the wall or other support, and without bending or otherwise damaging the cable.

For use in a system of the invention where the outlet cover is for a coaxial data cable wall outlet, FIGS. 4,5, and 24-28 illustrate examples of straight and curved embodiments of coaxial cable clip(s) of the invention for holding and/or supporting a coaxial cable firmly against or adjacent to a wall or support to prevent child or pet tampering.

Straight coaxial data clip 35, as shown in FIGS. 24 and 26, has a planar back 39 from which a closed side 40 beings at or near a right angle and then curves into an arc above and across the interior surface of planar back side 39 thereby forming an arced front 38 which is semi-circular to nearly three-quarters round, creating a hollow channel or tube-like interior 47 for the clip with open ends 36 and approximating a “C” shaped or opening (and mouth side) 41 of the clip 35, for receiving and holding the cable 30. The clip 35 is capable of tightly and removably receiving the cable 30, in the opening (and mouth side) 41, with the interior 47 of the clip 35 corresponding to or complementing the tubular shape of the cable, and sized to conform to or “match” the cable circumference for a tight or snug fit to resist tampering by children and pets.

In one embodiment the planar back 39 can be slightly longer then the front 38, as shown in FIGS. 24 and 26. In one embodiment, the exterior edges of the planar back 39 of the clip 35 are at ninety degrees to better accommodate affixers such as for example adhesive strip(s) 29 which are typically square or rectangular on the exterior surface of that planar back 39 of the clip 35 (as illustrated with the straight electrical clip 16 in FIG. 17). Such adhesive or adhesive strip 29 is preferably removable (but at least not easily by children) so as not to damage the wall or supporting surface to which the clip is being affixed. For ease of application, the adhesive or adhesive strip 29 is pressure-sensitive and coextensively covers the back surface of the planar back side of the clips. Other known affixers could also be used similarly and in some embodiments are removable.

The straight coaxial data cable clip can vary in length, as discussed with the straight electrical cord clip. Thus, the straight coaxial data cable clip can be, for example, one inch in length as shown in FIG. 24 or can be for example, two, three, four, five, six, seven, eight, etc. inches in length, or even approximately the length of the cable 30 extending from the outlet cover 31, as similarly discussed with the straight electrical cord clip. Also, as with the straight electrical cord clip, shorter straight cable data clips can be used in more variations for different paths for the cable 30 from the outlet cover 31 to the desired location for use of the cable functionality at the distal end of the cable 30. And longer straight cable data clips can be preferred for child protection in some embodiments.

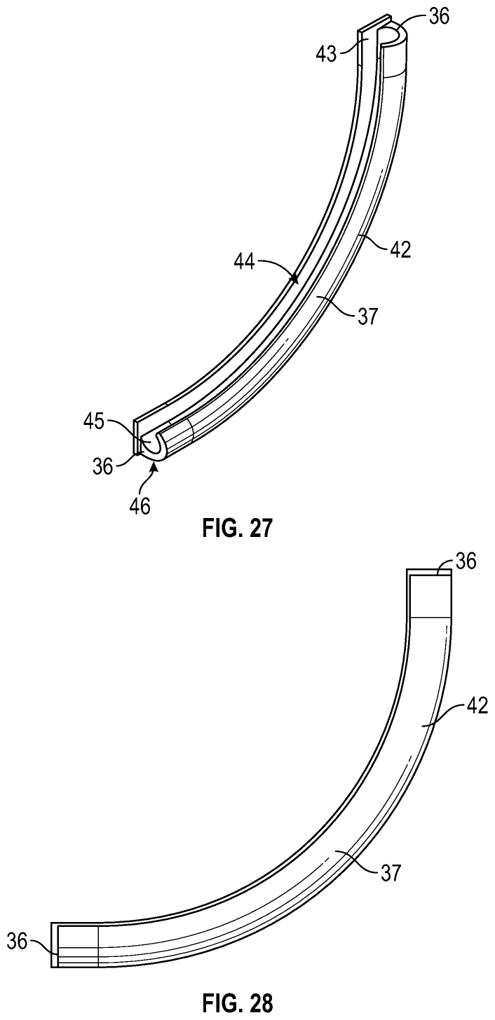

In one embodiment of curved cable data clip 37 of the invention, illustrated for example in FIGS. 27 and 28, curved cable data clip 37 is like straight cable data clip 35 except for the curve. End 36, shown in FIG. 25, is the same for curved cable data clip 37 as it is for straight cable data clip 35. This, curved cable data clip 37 has a planar back 43, a closed side 46 curving or arcing into an arc above and across the interior surface of planar back 43 and thereby forming an arced front side 42 which is semi-circular to nearly three-quarters round, creating a hollow channel or tube-like interior 45 for the clip 37 with open ends 36 and an approximate “C”-shaped opening (and mouth side) 44. The curve retention angle in this example embodiment is about 25 degrees, which is an obtuse curve that allows turning of the cable without damaging. Other angles can be used so long as the curve is not so acute as to damage the cable.

The following provides example dimensions of one illustrative example embodiment of a cable data clip of the invention, suitable for use in the system of the invention with an outer installation coaxial data cable ranging from about 0.242 inch to about 0.405 inch in diameter, as shown as clip 35 in FIG. 24. As shown, for example, in FIG. 24, the planar back 39 is about 1.118 inches in length and the curved front 42 is about 1.000 inch in length. The “C”-shaped opening 44 (and mouth side) is about 0.220 inch high, the clip 35 external height overall is about 0.413 inch and the internal height is about 0.392 inch. The cable retention angle is 25 degrees, which in this example has a radius of about 0.276 inch.

As illustrated in the Figures, and discussed above in referring to the Figures, the electrical cord used in the invention is shaped thin and flat and the coaxial cable used in the invention is shaped circumferentially round. However, the design and shape of the clip shown in the Figures for the coaxial cable could alternatively be used for an electrical cord that is circumferentially round but that is also suitable for use in the invention as an electrical cord as specified above.

While preferred embodiments of the present disclosure have been described, it should be understood that other various changes, adaptations, and modifications can be made therein without departing from the spirit of the invention(s) and the scope of the appended claims. The scope of the present disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A system for childproofing or aesthetically improving an indoor, functional, electrical or coaxial wall outlet on or in a wall, while retaining function of the outlet, said system comprising:
a. an indoor functional, electrical or coaxial, wall outlet cover respectively having at least one functional electrical cord or coaxial data cable extending therefrom with at least one respective electrical or coaxial plug or connector at the end of said cord or cable that is distal said wall outlet cover for moving the functionality of said wall outlet to said distal end of said cord or cable,
wherein said outlet cover hides said wall outlet and said outlet cover is sufficiently thin that it protrudes from the wall less than the depth of said plug or connector or less than about an inch; and
wherein said electrical cord is an SPT-2 or SPT-3, SVT or SJT, 16 or 14 AWG, 3 core multi-conductor electrical cord, and said coaxial data cable has an outside diameter of about 0.24 inches to about 0.50 inches;
b. at least one clip corresponding to or complementing said at least one functional electrical or coaxial cord, for receiving and holding at least a portion of said cord or cable firmly in place adjacent the wall proximate said wall outlet and at a depth less than the depth of said plug or connector or less than or about an inch, and for aesthetically and controllably routing said distal end of said cord or cable to a desired location for use of said functionality;
wherein said clip is affixable to said wall; and
wherein the interior perimeter or space of the clip corresponds or is complementary to the exterior perimeter or shape of the cord or cable for a fit sufficiently tight that child tampering is prevented or deterred.

2. The system of claim 1 wherein at least one said clip is a straight clip.

3. The system of claim 1 wherein said at least one clip is curved for turning the direction of at least one said cord or cable along said wall while holding said cord or cable firmly against said wall.

4. The system of claim 1 wherein said at least one clip is elongated, and either one clip alone or combined with like clips, can cover substantially all of each cord for childproofing said cord.

5. The system of claim 1 comprising at least one straight clip and at least one curved clip.

6. The system of claim 1 wherein said at least one clip is removably affixable to said wall with an adhesive comprised of an acrylic polymer material which forms a strong, lasting and flexible bond between said clip and said wall.

7. The system of claim 1 wherein said wall outlet is an electrical wall outlet and said at least one clip generally has planar or flat front and back parallel sides that are square or rectangular in shape, joined or connected by a curved or flat side and a side opposing that curved or flat side creating a hollow channel or tube-like interior, which said opposing side has a “V-shaped” slit or concave opening pointing toward said interior for receiving at least a portion of one electrical cord such that at least a partial length of the electrical cord is encased or gripped in said hollow channel or tube-like interior.

8. The system of claim 1 wherein said wall outlet is a coaxial wall outlet and said at least one clip has a flat back, a curved front arcing from and over the interior of said flat back forming a hollow channel or tube-like interior and a “C”-shaped side opening for receiving at least a portion of one said coaxial cord within said interior.

9. A clip for use in the system of claim 1 wherein the clip is a straight clip for receiving, holding or supporting at least a portion, section, or length of an electrical cord firmly against an adjacent wall or support, wherein said electrical cord has a specific outer perimeter or shape, and wherein said clip comprises:
a planar front side;
a planar back side having a flat exterior surface;
a closed side that is straight or curved joining or connecting the planar front side to the planar back side;
a side opposing said closed side, which in combination with said closed side and said planar front side and planar back side creates a channel or tube-like interior, and which has a concave “V” shaped opening pointing toward and for receiving and encasing within said channel or tube-like interior at least a portion, section, or length of said electrical cord; and
open ends leading to the channel or tube-like interior, which interior is shaped and sized complimentary or corresponding to said specific outer perimeter or shape of said electrical cord so that when the clip receives and encases said at least a portion, section, or length of said cord, the cord fits tightly or firmly within said interior and extends out of one or both said ends; and
wherein said clip has an affixer on the flat exterior surface of said planar back side for affixing said clip to said wall or other support.

10. The clip of claim 9 sized for an electrical SPT-2 cord or sized for an electrical SPT-3 cord, and having a minimal profile and unobtrusive appearance.

11. The clip of claim 9 wherein said clip is less than or about one inch in thickness and is comprised of a single piece of extruded plastic or polymer material.

12. A clip for use in the system of claim 1 wherein the clip is a curved clip for holding or supporting at least a portion, section, or length of an electrical cord firmly against an adjacent wall or support, wherein said electrical cord has a specific outer perimeter or shape, and wherein said clip comprises:
a curved planar front side;
a curved planar back side having a flat exterior back surface;
a closed side that is straight or curved joining or connecting the planar front side to the planar back side;
a side opposing said closed side, which in combination with said closed side and said planar front side and planar back side creates a channel or tube-like curved interior, and which has a concave “V”-shaped opening pointing toward and for receiving within said channel or tube-like interior at least a portion, section, or length of said electrical cord; and
open ends leading to the curved channel or tube-like interior, which interior is shaped and sized complimentary or corresponding to said specific outer perimeter or shape of said electrical cord so that the cord fits tightly or firmly within said interior when the clip receives, supports, or holds said at least a portion, section, or length of said cord, and such that the cord extends out of one or both said ends; and
an affixer on the flat exterior surface of said planar back side for affixing said clip to said wall or other support.

13. The clip of claim 12 sized for an electrical SPT-2 cord or sized for an electrical SPT-3 cord, and the curve of said curved clip provides a quarter circle turn.

14. The clip of claim 13 wherein said clip is less than about one inch in thickness and is comprised of a single piece of extruded plastic or polymer material.

15. A clip for use in the system of claim 1 wherein the clip is a coaxial data curved clip for holding or supporting at least a portion, section, or length of a coaxial cable firmly against an adjacent wall or support, and wherein said clip comprises:
a curved planar back having a flat exterior surface;
a closed curved side extending in a curved arc above and over said planar curved back, creating a hollow curved channel or tube-like interior with open ends and further creating a “C”-shaped opening into said channel or tube-like interior for receiving and holding said at least a portion, section, or length of said coaxial data cable;
wherein said channel or tube-like interior is shaped and sized complimentary or corresponding to the outer perimeter or shape of said coaxial data cable so that the cable fits tightly or firmly within said interior when received by said clip and said cable extends out of at least one of said ends; and
wherein said clip has an affixer on the flat exterior surface of said planar back for affixing said clip to said wall or other support.

16. The clip of claim 15 sized for an outer installation coaxial cable ranging from about 0.24 inch to about 0.40 inch in diameter and wherein the curve of said curved clip is about 25 degrees.

17. A clip for use in the system of claim 1 wherein the clip is a coaxial data straight clip for holding or supporting at least a portion, section, or length of a coaxial cable firmly against an adjacent wall or support, and wherein said clip comprises:
a planar back having a flat exterior surface;
a closed side extending in a curved arc above and over said planar back side, creating a hollow channel or tube-like interior with open ends and further creating a “C”-shaped opening into said channel or tube-like interior for receiving and holding said at least a portion, section, or length of said coaxial data cable;
wherein said channel or tube-like interior is shaped and sized complimentary or corresponding to the outer perimeter or shape of said coaxial data cable so that the cable fits tightly or firmly within said interior when gripped or received by said clip; and said cable extends out of at least one of said ends; and
wherein said clip has an affixer on the flat exterior surface of said planar back for affixing said clip to said wall or other support.

18. The clip of claim 17 sized for an outer installation coaxial cable ranging from about 0.24 inch to about 0.40 inch in diameter.

19. A method for childproofing a functional electrical or coaxial data wall outlet, while functionally moving and aesthetically hiding the wall outlet and securing a respective electrical cord or data cable to the wall, said method comprising,
plugging or otherwise functionally inserting into or on said wall outlet a functional indoor wall outlet cover sized to completely cover said outlet, hiding the outlet receptacles from children,
wherein said wall outlet cover protrudes from the wall less than about one inch and has at least a substantially blank face such that it is unobtrusive and aesthetically pleasing but unnoticeable and uninteresting to children and pets, and
wherein said functional indoor wall outlet has extending therefrom one or two functional electrical cords or one or two coaxial data cables, protruding from the wall less than about one inch, and for each respective cord or cable, respectively having a functional plug or connector at each cord or cable end distal the wall outlet; and wherein said one or two electrical cords are each a SPT-2 or SPT-3, SVT or SJT, 16 or 14 AWG, 3 core multi-conductor electrical cord, and said one or two coaxial data cables each have an outside diameter in the range of about 0.24 inches to about 0.50 inches;
routing said cord or cable along said wall, from the wall outlet cover in a desired and aesthetically pleasing path safe from children, to the desired location for use of each said functional plug or connector;
enclosing at least some portion of said cord or cable within one or more respective electrical cord clips or coaxial cable data clips as needed to hold or support said cord or cable firmly and tightly against said wall along said desired path such that said cord or cable and clip or clips protrude less than or about one inch from said wall and thus are unobtrusive and aesthetically pleasing but unnoticeable and uninteresting to children; and said cord or cable is not removable from the clip(s) by children and the cord or cable is not accessible to children,
wherein each said clip mimicks said outlet cover in appearance, having a substantially blank face that is unobtrusive and aesthetically pleasing but uninteresting and unnoticeable to children and pets, and wherein each said clip protrudes from the wall less than about one inch, and
wherein each said clip corresponds to or complements said cord or cable for receiving and holding the cord or cable firmly in place adjacent the wall proximate said wall outlet and wherein the interior perimeter or space of the clip corresponds to or is complementary in size and shape to the exterior perimeter or shape of the cord or cable for a fit sufficiently tight that child tampering is prevented or deterred, and
wherein each said clip has a strong albeit removable affixer on said planar back side for firmly affixing said clip to said wall or other support; and
optionally positioning furniture adjacent said wall in front of or against said outlet cover to further make said wall outlet inaccessible to children and pets.

20. The method of claim 19 wherein the affixer is comprised of an acrylic polymer adhesive material which forms a strong, lasting and flexible bond between said clip and said wall.
